(19) United States
(12) Patent Application Publication
(10) Pub. No.: US 2013/0230480 A1
(43) Pub. Date: Sep. 5, 2013

(54) WATER DISPERSION TYPE SUSTAINED RELEASE PREPARATION FOR RELEASING VOLATILE ACTIVE SUBSTANCE

(71) Applicant: NISSIN CHEMICAL INDUSTRY CO., LTD., Echizen-shi (JP)

(72) Inventors: Ryuichi Saguchi, Joetsu-shi (JP); Takehiko Fukumoto, Joetsu-shi (JP); Masahiko Ikka, Echizen-shi (JP); Kouji Kinoshita, Echizen-shi (JP); Hiroyuki Saitou, Echizen-shi (JP); Yoshihiro Ozawa, Echizen-shi (JP)

(73) Assignee: Nissin Chemical Industry Co., Ltd., Echizen-shi (JP)

(21) Appl. No.: 13/866,327

(22) Filed: Apr. 19, 2013

Related U.S. Application Data
(63) Continuation of application No. PCT/JP2012/078878, filed on Nov. 7, 2012.

(30) Foreign Application Priority Data
Nov. 7, 2011 (JP) 2011-243665

(51) Int. Cl. A01N 25/04

(52) U.S. Cl. CPC A01N 25/04
USPC 424/84; 524/391; 524/503; 524/354; 514/86; 512/26

(57) ABSTRACT

There is provided a a sustained release preparation including a dispersion for a sustained release preparation and a volatile active substance, the dispersion having viscosity at 25° C. of not more than 100 mPa·s and including polymer particles which are obtained by polymerizing ethylenically unsaturated group-containing monomers (A), polyvinyl alcohol (C1) in an amount of more than 0% by weight but not more than 30% by weight relative to a total amount of the ethylenically unsaturated group-containing monomers (A), having a degree of saponification of more than 82 mol % but not more than 91.5 mol %, polyvinyl alcohol (C3) in an amount of more than 0% by weight but not more than 30% by weight relative to the total amount of the ethylenically unsaturated group-containing monomers (A), having a degree of saponification of not less than 98 mol %, and water.

### RELATED APPLICATIONS

This application is a continuation of PCT/JP2012/078878, filed on Nov. 7, 2012, which claims priority from Japanese Application No. 2011-243665, filed on Nov. 7, 2011, the contents of which are incorporated herein by reference in their entireties.

### BACKGROUND OF THE INVENTION

The present invention relates to a water dispersion type sustained release preparation for releasing a volatile active substance. More specifically, the present invention relates to a water dispersion type sustained release preparation for releasing a volatile active substance, the preparation having low viscosity and a sufficient adhesion property suitable for an aerial spray from an aircraft or a helicopter or a ground spray from a vehicle such as a tractor, comprising a volatile active substance and a polymer water dispersion, and continuously releasing the volatile active substance at a constant rate over a long period of time after the spray.

### FIELD OF THE INVENTION

A sex pheromone has been utilized as a method for attracting or disrupting agricultural pests. For example, when the sex pheromone is applied to farmland, agricultural pests are attracted and collected by the sex pheromone. Because a mating ability for sensing or positioning the opposite sex is disrupted, procreation by mating is suppressed. The uniform release is generally attempted by using a sustained release preparation. It is necessary to uniformly release the sex pheromone for a period of not less than six weeks since a mating period of agricultural pests continues over the period. In addition, if the sex pheromone easily drops out owing to rain or wind, the sex pheromone is not uniformly released and the effect is not exhibited.

In the development of sustained release preparations, a sustained release preparation obtained by micro-capsuling a sex pheromone with a cellulose derivative (JP 58-183601A), sustained release preparations obtained by impregnating sex-pheromone-compatible synthetic resin pellets with a sex pheromone substance, pulverizing the pellets, and further coating the surfaces of the pulverized pellets with inorganic powder or granules or a synthetic resin which is not compatible with the pheromone substance (JP 61-92024A), a sustained release preparation obtained by mixing a synthetic resin pellet containing a sex pheromone substance with 0/W type acrylic adhesive emulsion and suspending (JP 7-231743A) and the like have been disclosed. In addition, synthetic resin emulsion obtained from a polymerizable monomer having a specific functional group and one or more selected from unsaturated monocarboxylate ester, unsaturated dicarboxylate diester and aliphatic vinyl has been disclosed (JP 60-252403A and JP 61-5001A).

Furthermore, an attempt to solve the above problem by a micro-capsule technology utilizing polymer particles has been made in recent years. For example, a water dispersion type sustained release preparation characterized by comprising a sex pheromone in a micro gel made of a monomer component comprising a (meth)acrylate ester monomer and a multifunctional (meth)acrylate ester monomer is disclosed in JP 2001-158843A. A water dispersion type sustained release preparation having a sex pheromone release inhibitor further mixed is disclosed in JP 2004-331625A. Furthermore, micro-capsuling of a sex pheromone by multi-stage emulsion polymerization is disclosed in JP 2006-35210A. However, the aforementioned problem, particularly the problem of uniformly releasing substantially all of the comprised sex pheromone has not been fully solved in any of the above examples, and also, complicated steps such as pulverization, micro-capsuling and multi-stage polymerization have been required.

In addition, the above-mentioned studies on materials other than the sex pheromone have been conducted. For example, an application of a complex resin of polyurethane and vinyl polymer as a repellent, an antibacterial fungicide and an aromatic is disclosed in JP 2005-290034A. An application of a biodegradable resin including random or block copolyester for fragrance is disclosed in JP 11-106629A. However, the aforementioned problem has not necessarily been solved. Furthermore, a sustained release functional agent in which a functional material and a hydrophobic substance are embedded in a kneaded state in pores of a hydrophilic porous body having many pores which are open in the surface thereof and having a specific surface area of not less than 0.1 m²/g is disclosed in JP 10-17846A. A porous hollow polymer particle having a plurality of cavities therein is disclosed in JP 2009-120806A. However, the aforementioned problem has not been fully solved in any of the above examples, and complicated steps have been required.

### SUMMARY OF THE INVENTION

The present invention has been made in order to solve the problems in the related art, and provides a water dispersion type sustained release preparation for releasing a volatile active substance at a constant rate over a long period of time until substantially all the content of which can be released and which has low viscosity and a sufficient adhesion property.

As a result of an intensive study for achieving the above object, the present inventors have discovered that it is possible to release all the contents of the water dispersion type sustained release preparation for releasing a volatile active substance at a constant rate over a long period of time as described below, and that the preparation has low viscosity and a sufficient adhesion property, and have completed the present invention.

According to the present invention, there is provided a water dispersion for a sustained release preparation, the dispersion having viscosity at 25° C. of not more than 100 mPa·s and comprising polymer particles which are obtained by polymerizing ethylenically unsaturated group-containing monomers (A), polyvinyl alcohol (C1) in an amount of more than 0% by weight but not more than 30% by weight relative to a total amount of the ethylenically unsaturated group-containing monomers (A), having a degree of saponification of more than 82 mol % but not more than 91.5 mol %, polyvinyl alcohol (C3) in an amount of more than 0% by weight but not more than 30% by weight relative to the total amount of the ethylenically unsaturated group-containing monomers (A), having a degree of saponification of not less than 98 mol %, and water, wherein a total amount of the polyvinyl alcohol (C1) and (C3) relative to the total amount of ethylenically unsaturated group-containing monomers (A) is more than 0% by weight but not more than 50% by weight.

In addition, according to the present invention, there is provided a sustained release preparation comprising the water dispersion and a volatile active substance selected from a group consisting of a pheromone substance, an agricultural chemical, an aromatic, a deodorant and antibacterial agent.

Furthermore, according to the present invention, there is provided a method for producing a water dispersion for a sustained release preparation, comprising a polymerization step of emulsion-polymerizing ethylenically unsaturated group-containing monomers (A) in the presence of polyvinyl alcohol to obtain a polymer particle water dispersion having viscosity at 25° C. of not more than 100 mPa·s, wherein the polyvinyl alcohol is selected from polyvinyl alcohol (C1) having a degree of saponification of more than 82 mol % but not more than 91.5 mol % and polyvinyl alcohol (C3) having a degree of saponification of not less than 98 mol %; and when the polyvinyl alcohol is a combination of the polyvinyl alcohols (C1) and (C3), both of the polyvinyl alcohols (C1) and (C3) are present during the polymerization, or one of the polyvinyl alcohols (C1) and (C3) is present during the polymerization and the other of the polyvinyl alcohols, which is not present during the polymerization, is blended after the polymerization, so that the polyvinyl alcohol (C1) is in an amount of more than 0% by weight but not more than 30% by weight, the polyvinyl alcohol (C3) is in an amount of more than 0% by weight but not more than 30% by weight, and a total amount of the polyvinyl alcohols (C1) and (C3) is more than 0% by weight but not more than 50% by weight relative to a total amount of the ethylenically unsaturated group-containing monomers (A).

According to the present invention, provided is a water dispersion type sustained release preparation for releasing a volatile active substance at a constant rate over a long period of time until substantially all the content of which can be released and which has low viscosity and a sufficient adhesion property.

### BRIEF DESCRIPTION OF DRAWINGS

FIG. 1 is a graph exhibiting a relationship between remaining amounts of pheromone and elapsed days in Examples 1 to 12 and Comparative Examples 1 and 2.

FIG. 2 is a graph exhibiting a relationship between remaining amounts of pheromone and elapsed days in Examples 13, 17, 20, 23, and 26.

FIG. 3 is a graph exhibiting a relationship between remaining amounts of pheromone and elapsed days in Examples 28 to 32.

FIG. 4 is a graph exhibiting a relationship between remaining amounts of pheromone and elapsed days in Examples 33 to 37.

### DESCRIPTION OF THE EMBODIMENTS OF THE INVENTION

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. Unless otherwise defined, all technical and scientific terms used herein have the same meaning as commonly understood by one of ordinary skill in the art to which this invention belongs. All references cited are incorporated herein by reference in their entirety.

It should also be understood that many modifications and variations of the described embodiments of the invention will occur to a person having an ordinary skill in the art without departing from the spirit and scope of the present invention as claimed in the appended claims.

Examples of the ethylenically unsaturated group-containing monomers (A) to be used in the present invention include olefin hydrocarbon monomers such as ethylene and propylene; vinyl carboxylate monomers such as vinyl acetate and vinyl propionate; chlorine-containing ethylene monomers such as vinyl chloride and vinylidene chloride; aromatic vinyl monomers such as styrene and α-methylstyrene; conjugated diene monomers such as 1,3-butadiene and 2-methyl-1,3-butadiene; ethylenically unsaturated monocarboxylate ester monomers such as methyl acrylate, ethyl acrylate, butyl acrylate, 2-ethylhexyl acrylate and methyl methacrylate; ethylenically unsaturated dicarboxylate ester monomers such as dimethyl itaconate, diethyl maleate, monobutyl maleate, monoethyl fumarate and dibutyl fumarate; ethylenically unsaturated monocarboxylic acid monomers such as acrylic acid, methacrylic acid and crotonic acid; and ethylenically unsaturated dicarboxylic acid monomers such as itaconic acid, maleic acid and fumaric acid; epoxy group-containing ethylenically unsaturated monocarboxylate ester monomers such as glycidyl methacrylate; alcohol group-containing ethylenically unsaturated monocarboxylate ester monomers such as 2-hydroxyethyl methacrylate; alkoxyl group-containing ethylenically unsaturated monocarboxylate ester monomers such as methoxyethyl acrylate; nitrile group-containing ethylene monomers such as acrylonitrile; amide group-containing ethylene monomers such as acrylamide; amino group-containing ethylenically unsaturated monocarboxylate ester monomers such as dimethylaminoethyl methacrylate; and monomers containing two or more ethylenically unsaturated groups in one molecule such as divinylbenzene and allyl methacrylate. The vinyl carboxylate monomers and ethylenically unsaturated monocarboxylate ester are preferable.

The number of carbon atoms in the ethylenically unsaturated group-containing monomers (A) preferably ranges from 2 to 13 including the number of carbon atoms in the functional group.

In addition, a glass-transition temperature T of the polymer particles obtained by polymerizing the ethylenically unsaturated group-containing monomers (A) (hereinafter, the glass-transition temperature may be referred to as Tg) is preferably not more than 30° C., more preferably from −50° C. to 30° C. in consideration of a point that the applied sustained release preparation is adhered to leaves and does not fall to the ground. The monomer is selected using the following equation.

(Pa+Pb+Pc)/T=(Pa/Ta)+(Pb/Tb)+(Pc/Tc). (1)

In Equation (1), T represents a glass-transition temperature (K) of the polymer particles, Pa, Pb and Pc represent contents (% by weight) of the monomers a, b and c, respectively, and Ta, Tb, and Tc represent homopolymer glass-transition temperatures (K) of the monomer a, b, and c, respectively.

The glass-transition temperature can be measured based on JIS K 7121.

According to the present invention, two or more kinds of polyvinyl alcohols (hereinafter, referred to as “PVAs” in some cases) are present in a system. The ethylenically unsaturated group-containing monomers (A) may be polymerized in the presence of the two or more kinds of PVAs, or may be polymerized in the presence of one part of the two or more kinds of PVAs and then subjected to an addition of the other part (e.g. the other kind or kinds) of the two or more kinds of PVAs.

Specifically, in the polymerization step of emulsion-polymerizing the ethylenically unsaturated group-containing monomers (A) in the presence of polyvinyl alcohol to obtain a polymer particle water dispersion, the polyvinyl alcohol is selected from the polyvinyl alcohol (C1) having a degree of saponification of more than 82 mol % but not more than 91.5 mol % and the polyvinyl alcohol (C3) having a degree of saponification of not less than 98 mol %. Both of the polyvinyl alcohols (C1) and (C3) are present during the polymerization, or one part of the polyvinyl alcohols (C1) and (C3) is present during the polymerization and the other part of the polyvinyl alcohols (C1) and (C3) is blended after the polymerization, so that the polyvinyl alcohol (C1) is in an amount of more than 0% by weight but not more than 30% by weight, the polyvinyl alcohol (C3) is in an amount of more than 0% by weight but not more than 30% by weight, and the total amount of the polyvinyl alcohols (C1) and (C3) is more than 0% by weight but not more than 50% by weight relative to the total amount of the ethylenically unsaturated group-containing monomers (A).

In a preferable embodiment, the polyvinyl alcohol (C1) in an amount of more than 0% by weight but not more than 30% by weight relative to the total amount of the ethylenically unsaturated group-containing monomers (A) is used during the polymerization, and the polyvinyl alcohol (C3) in an amount of more than 0% by weight but not more than 30% by weight relative to the total amount of the ethylenically unsaturated group-containing monomers (A) is blended after the polymerization, while keeping the total amount of the polyvinyl alcohols (C1) and (C3) more than 0% by weight but not more than 50% by weight relative to the total amount of the ethylenically unsaturated group-containing monomers (A).

In another preferable embodiment, the polyvinyl alcohol (C3) in an amount of more than 0% by weight but not more than 30% by weight relative to the total amount of the ethylenically unsaturated group-containing monomers (A) is present during the polymerization, and the polyvinyl alcohol (C1) in an amount of more than 0% by weight but not more than 30% by weight relative to the total amount of the ethylenically unsaturated group-containing monomers (A) is blended after the polymerization, while keeping the total amount of the polyvinyl alcohols (C1) and (C3) more than 0% by weight but not more than 50% by weight relative to the total amount of the ethylenically unsaturated group-containing monomers (A).

In a still another preferable embodiment, both the polyvinyl alcohols (C1) and (C3) are present during the polymerization, each in an amount of more than 0% by weight but not more than 30% by weight relative to the total amount of the ethylenically unsaturated group-containing monomers (A), while keeping the total amount of the polyvinyl alcohols (C1) and (C3) more than 0% by weight but not more than 50% by weight relative to the total amount of the ethylenically unsaturated group-containing monomers (A). Thus, the blending after the polymerization is not performed.

According to the present invention, if the water dispersion or the sustained release preparation is produced in a system where the polyvinyl alcohol is absent, the volatile active substance is not sufficiently released, and release of the volatile active substance cannot be controlled.

The degree of saponification of PVA to be used in the present invention is preferably more than 82 mol %. When the degree of saponification is not more than 82 mol %, the amount of remaining acetate in PVA is large so that compatibility with the volatile active substance becomes higher. As a result, there may be defect that a desired release rate cannot be achieved, or defect that some of the volatile active substance is not released and is wasted. In addition, although a degree of polymerization of PVA is not particularly limited, an aqueous solution of PVA having a high degree of polymerization may have high viscosity and it may become necessary to reduce an evaporation residue in order to obtain proper viscosity of the polymer particle water dispersion. In order to reduce the evaporation residue, the volatile active substance for impregnation is decreased. Accordingly, an average degree of polymerization calculated based on JIS K 6726 is preferably from 400 to 2000, more preferably from 500 to 1700.

Here, since it is considered that the polymer part inside the emulsion particle is more hydrophobic than an external dispersant so that it is considered that the inside of the emulsion particle is impregnated with the hydrophobic volatile active substance.

Examples of the polymerization initiator to be used in the present invention include persulfate salts such as sodium persulfate, ammonium persulfate and potassium persulfate; azo compounds such as 2,2′-diamidino-2,2′-azopropane dihydrochloride salt and azobisisobutyronitrile; peroxide such as cumene hydroperoxide, benzoyl peroxide and hydrogen peroxide. In addition, a known redox initiator such as potassium persulfate and sodium hydrogen sulfite can also be included. The amount of the polymerization initiator is typically from 0.05 to 10% by weight, preferably from 0.1 to 2% by weight relative to the total amount of the monomers.

According to the present invention, the temperature at which the polymer particle water dispersion is produced is generally 30° C. to 95° C., preferably 60° C. to 80° C., and the polymerization time is generally 3 to 20 hours, preferably 4 to 8 hours. The polymerization is carried out preferably in an atmosphere of inert gas such as nitrogen gas.

The weight-average molecular weight of the polymer produced by polymerization of the ethylenically unsaturated group-containing monomers (A) is preferably from 100,000 to 1 million, more preferably from 100,000 to 800,000 in terms of polystyrene measured by using gel permeation chromatography (GPC).

The solid content of the polymer particle water dispersion is preferably from about 30 to 65% by weight.

In addition, an ethylenically unsaturated group-containing monomer having a functional group can be comprised in an amount which does not compromise the effect of the present invention. Such examples include epoxy group-containing monomers such as glycidyl methacrylate; methylol group-containing monomers such as N-methylolacrylamide; alcoholic hydroxyl group-containing monomers such as 2-hydroxyethyl methacrylate; alkoxyl group-containing monomers such as methoxyethyl acrylate; nitrile group-containing monomers such as acrylonitrile; amide group-containing monomers such as acrylamide; amino group-containing monomers such as dimethylaminoethyl methacrylate; and monomers having two or more ethylenically unsaturated groups in one molecule such as divinylbenzene and allyl methacrylate.

As for the polymerization in the present invention, any known polymerization methods such as emulsion-polymerization method can be employed. The monomer and a polymerization aid may be added all at once in an initial stage, or may be continuously added, or one part of the monomer and the polymerization aid may be added in an initial stage and the other part thereof may be continuously or dividedly added during the polymerization. The polymerization aid includes an emulsifier such as alkyl sulfuric acid ester salt, a polymerization initiator such as ammonium persulfate, a chain transfer agent such as mercaptans, a pH adjuster such as sodium carbonate, and various kinds of defoaming agent.

According to the present invention, the water dispersion type sustained release preparation comprises a water dispersion comprising polymer particles which are obtained by polymerizing the ethylenically unsaturated group-containing monomers (A), polyvinyl alcohol (C1) having a degree of saponification of more than 82 mol % but not more than 91.5 mol % and polyvinyl alcohol (C3) having a degree of saponification of not less than 98 mol %.

Each of the polyvinyl alcohol (C1) having a degree of saponification of more than 82 mol % but not more than 91.5 mol % and the polyvinyl alcohol (C3) having a degree of saponification of not less than 98 mol % is used in an amount of more than 0% by weight but not more than 30% by weight, preferably from 5 to 25% by weight relative to the total amount of the ethylenically unsaturated group-containing monomers (A). When the amount exceeds 30% by weight, there is defect that the polymer particle water dispersion becomes hydrophilic and after the polymer particle water dispersion is applied to a target and changed to a dried film, the dried film is re-emulsified by a small amount of rain or the like so that the volatile active substance falls off along with the polymer particles.

Furthermore, the total amount of the polyvinyl alcohols (C1) and (C3) preferably is more than 0% by weight but not more than 50% by weight, more preferably from 5 to 25% by weight relative to the total amount of the ethylenically unsaturated group-containing monomers (A). It should be noted that both of the polyvinyl alcohols (C1) and (C3) are present in the dispersion, each being in an amount of more than 0% by weight.

In addition, PVA having a special functional group such as anion-modified PVA, cation-modified PVA and terminally SH-modified PVA can also be used.

A molar ratio of a hydrophilic part to an acetate part will be explained. The molar ratio of hydrophilic part to acetate part is a ratio of a molar amount of the hydrophilic part which is a total molar amount of vinyl alcohol monomer units to a molar amount of the acetate part which is a total molar amount of vinyl acetate monomer units in the total amount of the polyvinyl alcohol.

When x parts by weight of polyvinyl alcohol (A) having a degree of saponification of 100a mol % and y parts by weight of polyvinyl alcohol (B) having a degree of saponification of 100P mol % are used, the following equations are obtained, provided that the molecular weight of the vinyl alcohol is 44 and the molecular weight of the vinyl acetate is 86.

Molar amount of Hydrophilic Part=xx44α/{44α+86(1−α)}/44+y×44β/{44β+86(1−β)}/44 (2)

Molar amount of Acetate Part=xx86(1−α)/{44α+86(1−α)}/86+y×86(1−β)/{44β+86(1−β)}/86 (3)

The molar ratio of hydrophilic part to acetate part is calculated by dividing a value obtained in Equation (2) by a value obtained in Equation (3).

In the total amount of the polyvinyl alcohols (C1) and (C3), the molar ratio of hydrophilic part to acetate part (molar ratio of hydrophilic part/acetate part) is preferably not more than 15.0, more preferably from 7.0 to 15.0. When the ratio exceeds 15.0, the release rate of the volatile active substance may become excessively high.

The volatile active substance to be used in the present invention is not particularly limited. Preferable examples thereof include a pheromone substance, an agricultural chemical, an aromatic, a deodorant and an antibacterial agent. When the compatibility between a volatile active substance and PVA becomes excessively high, the volatile active substance may be unreleased and remain. Accordingly, a volatile active substance is preferably at least one compound selected from a group consisting of acetate, alcohol (including phenol), epoxide, alkane, alkene, aldehyde, ketone, carboxylic acid, ester and ether, each having a boiling point (normal boiling point at 1 atm) of from 100° C. to 350° C. and having 6 to 20 carbon atoms. It is further preferable to select a compound having a boiling point of from 200° C. to 350° C. with respect to a pheromone substance and a compound having a boiling point of from 100° C. to 320° C. with respect to the volatile active substances other than the pheromone substance.

Examples of the pheromone substance for fruit tree pests include Z-8-dodecenyl acetate as sex pheromone of Oriental Fruit Moth (OFM), E,E-8,10-dodecadienol as sex pheromone of Codling Moth (CDM), and E-5-decenyl acetate as sex pheromone of Peach Twig Borer (PTwB). Examples of pheromone substance for forest pests include (±)-cis-7,8-epoxy-2-methyloctadecane as sex pheromone of Gypsy Moth (GM). Examples of sex pheromone for cotton pests include ZZ/ZE-7,11-hexadecadienyl acetate as sex pheromone of Pink Bollworm (PBW).

Examples of the agricultural chemical include an agricultural chemical having a relatively high vapor pressure such as diazinon and propylene glycol fatty acid monoester.

Examples of the aromatic include natural essential oils such as orange oil, lemon oil and lemongrass oil; hydrocarbon terpenes such as a-pinene, β-pinene and limonene; aldehydes such as heptanal, octanal and citral; ester such as ethyl formate and methyl acetate; lactonic acid; ethers such as anisole and p-cresyl methyl ether; alcohols such as trans-2-hexenol and leaf alcohol; ketones such as menthone and acetophenone.

Examples of the deodorant include a botanical extract type deodorant such as lauryl methacrylate and polyphenol; and a reactive type deodorant such as betaine compound.

Examples of the antibacterial agent include aldehydes such as phenylpropionic aldehyde and citral; and alcohols such as linalool and citronellol.

The amount of the volatile active substance comprised by the water dispersion type sustained release preparation (content before use, or initial content) is preferably from 3 to 20% by weight, more preferably from 5 to 10% by weight relative to the total amount of the ethylenically unsaturated group-containing monomers (A). When the amount is less than 3% by weight, the release rate may become extremely low. When the amount is more than 20% by weight, the release rate may become excessively high. The amount of the volatile active substance desirably reaches less than 5% by weight at the end of use, provided that the initial amount (the amount when the release is started) is 100% by weight. As for the pheromone substance, the remaining amount of the volatile active substance preferably becomes 60 to 75% by weight after 10 days, not more than 35% by weight after 60 days, and less than 5% by weight after 70 days to 120 days, provided that the initial amount is 100% by weight. As for the volatile active substance other than the pheromone substance, the remaining amount of the volatile active substance preferably becomes 60 to 80% by weight after 20 days, not more than 35% by weight after 90 days, and less than 5% by weight after 120 days to 250 days, provided that the initial amount is 100% by weight.

Most types of volatile active substances are lipophilic and not dissolved in water. When the volatile active substance is mixed with polymer particle water dispersion, the polymer particle water dispersion is impregnated with the volatile active substance.

The volatile active substance is added after the polymerization of the ethylenically unsaturated group-containing monomers (A).

The water dispersion type sustained release preparation is obtained by mixing the polymer particle water dispersion and the volatile active substance by using a known mixing preparation method such as use of a propeller type stirrer. The temperature for mixing may be a temperature at which the volatile active substance is not evaporated. It is preferably from 10 to 30° C. The stirring time is preferably from 5 minutes to 2 hours.

The time at which the volatile active substance is mixed may be after the polymerization step or before blending the polyvinyl alcohol after the polymerization.

The viscosity of the sustained release preparation obtained in the present invention is preferably not more than 100 mPa·s, further preferably from 30 to 100 mPa·s, Since the addition of the volatile active substance has substantially no influence on the viscosity of the sustained release preparation, the viscosity of the polymer particle water dispersion is preferably not more than 100 mPa·s, further preferably from 30 to 100 mPa·s. When the viscosity exceeds 100 mPa·s, the particle size during the spray increases, which may not be preferable. The viscosity at 25° C. can be measured by using a B-type viscosity meter.

The sustained release preparation can be sprayed, for example, through an aerial spray from an aircraft or a helicopter, or through a ground spray from a vehicle such as a tractor. It is also possible to utilize a conventional method in which a container filled with the sustained release preparation is installed. The sustained release preparation can be sprayed at a constant amount, for example, through a spray or an atomizing nozzle.

In addition, it is also possible to use a base material such as cotton cloth, wood, paper and plastic, which has been coated or impregnated with the sustained release preparation.

The spray amount of the volatile active substance is preferably from 50 to 3000 g/acre. The sprayed or applied sustained release preparation is formed, through air drying or heat drying, into a membrane, a film or a particle preferably having a thickness of from 0.5 to 500 μm, more preferably 1 to 100 μm, although depending on a sprayed or applied amount. Then the volatile active substance is released at a constant rate.

Hereinafter, the present invention will be explained based on Examples and Comparative Examples. However, it should not be construed that the present invention is limited to Examples.

### EXAMPLES

### Example 1

The 100 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator. The 100 parts by weight of vinyl acetate monomers, 25 parts by weight of aqueous 20 wt % (% by weight) solution of PVA (JP-05 produced by Japan VAM & POVAL Co., Ltd., a degree of saponification of 88 mol %, an average polymerization degree of 500), which was 5% by weight relative to the vinyl acetate monomers, and 36 parts by weight of ion-exchanged water were placed and stirred in a homo-mixer for five minutes to prepare a emulsion of monomers. After the emulsion was added dropwise into the four-necked flask for four hours, the polymerization was further continued for two hours. Then, the resulting mixture was reacted at 80° C. for one hour and cooled to 30° C. A polyvinyl acetate particle water dispersion having 40.3% by weight of evaporation residue and viscosity of 50 mPa·s was obtained.

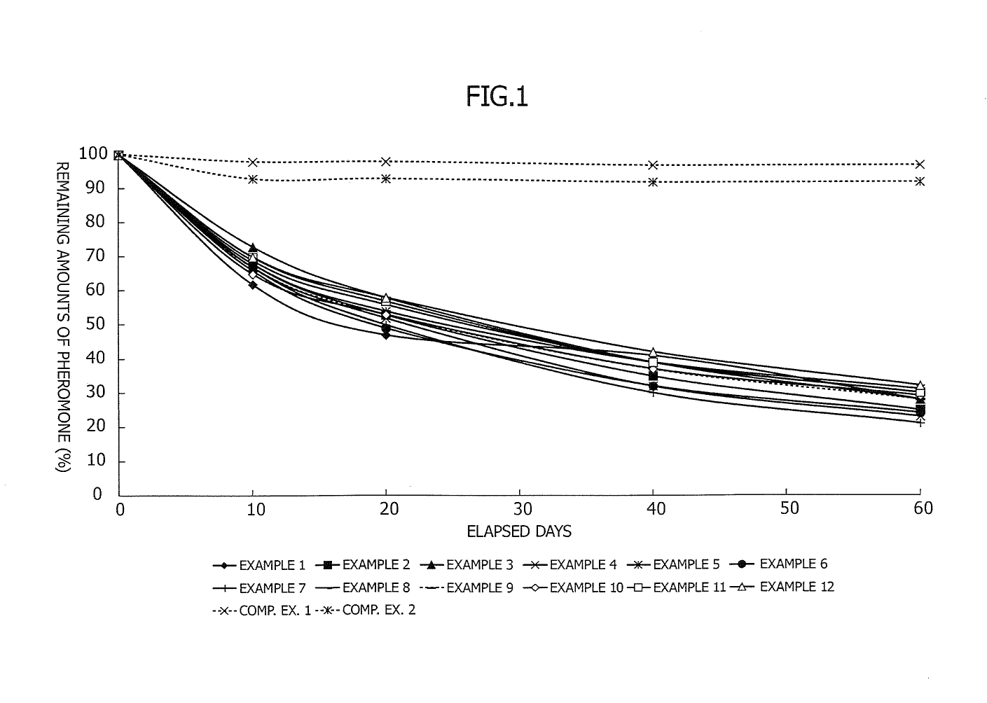

To the water dispersion, 5 parts by weight of Z-8-dodecenyl acetate (product of Shin-Etsu Chemical Co., Ltd., boiling point of 300° C.) as sex pheromone of OFM was added. The mixture was stirred at 25° C. for one hour. Thereafter, 60 parts by weight of aqueous 10 wt % solution of PVA (JF-17 produced by Japan VAM & POVAL Co., Ltd., a degree of saponification of 98.5 mol %, an average polymerization degree of 1700), which was 6% by weight relative to the vinyl acetate monomers, was added thereto. The mixture was further stirred at 25° C. for 30 minutes to produce a sustained release preparation. Then, the molar ratio of hydrophilic part/acetate part was calculated in the manner shown below, the evaporation residue and the viscosity of the polymer particle water dispersion were measured, and a weather resistant test and a volatile active substance release test of the sustained release preparation were conducted. The composition in each step is shown in Table 1, and the results are shown in Table 2 and FIG. 1.

### <Calculation of a Molar Ratio of Hydrophilic Part to Acetate Part>

$$Molar amount of hydrophilic part = 6 \times ( 44 \times 0.88 ) / \{ 44 \times 0.88 + 86 \times ( 1 - 0.88 ) \} / 44 + 6 \times ( 44 \times 0.985 ) / \{ 44 \times 0.985 + 86 \times ( 1 - 0.985 ) \} / 44 = 0.2401$$

$$Molar amount of acetate part = 6 \times 86 \times ( 1 - 0.88 ) / \{ 44 \times 0.88 + 86 \times ( 1 - 0.88 ) \} / 86 + 6 \times 86 \times ( 1 - 0.985 ) / \{ 44 \times 0.985 + 86 \times ( 1 - 0.985 ) \} / 86 = 0.0167$$

$$Molar ratio of hydrophilic part to acetate part = 0.2401 / 0.0167 = 14.4$$

### <Evaporation Residue>

A sample of about 1 g of the polymer particle water dispersion was precisely measured and placed on a dish made of aluminum foil. The sample on the dish was placed in a drier which had been maintained at about 105° C., and heated for one hour. It was taken out from the drier, and cooled in a desiccator. The weight of the sample after the drying was measured, and the evaporation residue was calculated by the following equation.

$$R = \frac{T - L}{W - L} \times 100$$

R: evaporation residue (% by weight)
W: weight of aluminum foil dish with sample thereon before drying (g)
L: weight of aluminum foil dish (g)
T: weight of aluminum foil dish with sample thereon after drying (g)
Dimension of aluminum foil dish: 70φ×height 12 (mm)

### <Viscosity Measuring Method by B-Type Viscosity Meter>

The liquid temperature of the polymer particle water dispersion was maintained at 25±1.0° C., and the viscosity was measured by a BM type viscosity meter (60 rpm).

### <Glass-Transition Temperature of Polymer>

The glass-transition temperature was measured based on JIS K 7121.

### <Weather Resistance>

Twelve dots of 2 μl of the obtained water dispersion type sustained release preparation containing the volatile active substance were marked on a glass plate and dried in a dryer at 25° C. for one day. The number of dots which fell off during watering from a watering pot for 10 minutes was checked.

High: all the twelve dots were held.
Medium: falling off of one or two dots among the twelve dots was observed.
Low: falling off of three or more dots among the twelve dots was observed.

### <Volatile Active Substance Release Test>

The 2 μl dot of the obtained water dispersion type sustained release preparation containing the volatile active substance was applied to a film made of polyethylene terephthalate, dried in a constant temperature and constant moisture room at 23° C. and 45% RH for 16 hours, to obtain the dried sustained release preparation containing volatile active substance.

Next, the preparation was installed in a dryer with a wind velocity of 0.7 m/second, and changes in weight were measured as a release rate of the volatile active substance from the preparation. In addition, the temperature in the dryer was set to 25° C. when the sustained release preparations contained sex pheromone of OFM, or CDM or PTwB which will be described later. The temperature in the dryer was set to 30° C. when the sustained release preparation contained sex pheromone of GM or PBW, which will be described later, or the other kind of volatile active substance.

As the release amount of the volatile active substance, the remaining amounts of the volatile active substance on 10th day, 20th day, 30th day and 40th day, or 20th day, 40th day, 60th day and 90th day are shown by a weight ratio relative to the initial amount (the amount when the release was started) of 100. In addition, the days when the remaining amount of the volatile active substance reached not more than 5% (weight ratio of not more than 5) were shown in Tables.

### Examples 2 to 12 and Comparative Examples 1 to 3

The polymer particle water dispersion and the sustained release preparation were produced based on the polymerization compositions with or without an addition after the polymerization as shown in Table 1 in the same manner as in Example 1. Then the same tests as those in Example 1 were conducted. The used PVA included JP-05 (product of Japan VAM & POVAL Co., Ltd., a degree of saponification of 88 mol %, an average polymerization degree of 500), PVA-706 (product of Kuraray Co., Ltd., a degree of saponification of 91.5 mol %, an average polymerization degree of 600), JF-05 (product of Japan VAM & POVAL Co., Ltd., a degree of saponification of 98.5 mol %, an average polymerization degree of 500), JF-17 (product of Japan VAM & POVAL Co., Ltd., a degree of saponification of 98.5 mol %, an average polymerization degree of 1700), and JL-05E (product of Japan VAM & POVAL Co., Ltd., a degree of saponification of 82 mol %, an average polymerization degree of 500). The used sex pheromone included Z-8-dodecenyl acetate (product of Shin-Etsu Chemical Co., Ltd., boiling point of 300° C.) as sex pheromone of OFM, E,E-8,10-dodecadienol (product of Shin-Etsu Chemical Co., Ltd., boiling point of 271° C.) as sex pheromone of CDM, (±)-cis-7,8-epoxy-2-methyloctadecane (product of Shin-Etsu Chemical Co., Ltd., boiling point of 332° C.) as sex pheromone of GM, E-5-dodecenyl acetate (product of Shin-Etsu Chemical Co., Ltd., boiling point of 211° C.) as sex pheromone of PTwB, and ZZ/ZE-7,11-hexadecadienyl acetate (product of Shin-Etsu Chemical Co., Ltd., boiling point of 349° C.) as sex pheromone of PBW. In Comparative Example 3, the sustained release preparation was produced in the same manner as in Example 1 except that PVA was not used and surfactant PERSOFT EL (product of NOF Corporation, anion surfactant of sodium polyoxyethylene laurylether sulfate, molecular weight of 420) was used. The results are shown in Table 2 and FIG. 1.

TABLE 1

| | polymerization step | | | | | | after polymerization | | | |
|---|---|---|---|---|---|---|---|---|---|---|
| | (parts by weight) | | | | | | (parts by weight) | | | |
| | monomer | | | polyvinyl | polyvinyl | | | | polyvinyl | polyvinyl |
| | vinyl | Ethyl | butyl | alcohol | alcohol | | | | alcohol | alcohol |
| | acetate | acrylate | acrylate | (C1) *1 | (C3) *1 | surfactant | pheromone | | (C1) *1 | (C3) *1 |
| Example 1 | 100 | — | — | 6 (P) | — | — | OFM | 5 | — | 6 (F17) |
| Example 2 | 100 | — | — | 19 (P) | — | — | OFM | 5 | — | 15 (F17) |
| Example 3 | 100 | — | — | 10 (A) | — | — | OFM | 5 | — | 5 (F05) |
| Example 4 | 100 | — | — | 6 (P) | — | — | CDM | 5 | — | 6 (F17) |
| Example 5 | 100 | — | — | 6 (P) | — | — | GM | 5 | — | 6 (F17) |
| Example 6 | 100 | — | — | 6 (P) | — | — | PTwB | 5 | — | 6 (F17) |
| Example 7 | 100 | — | — | 6 (P) | — | — | PBW | 5 | — | 6 (F17) |
| Example 8 | 50 | — | 50 | 6 (P) | — | — | OFM | 5 | — | 5 (F17) |
| Example 9 | — | 20 | 80 | 6 (P) | — | — | OFM | 5 | — | 6 (F17) |
| Example10 | 100 | — | — | 6 (P) | — | — | OFM | 3.5 | — | 6 (F17) |
| Example11 | 100 | — | — | 6 (P) | — | — | OFM | 10 | — | 6 (F17) |
| Example12 | 100 | — | — | — | 6 (F17) | — | OFM | 5 | 9 (P) | — |
| Comp. Ex. 1 | 100 | — | — | 40 (A) | — | — | OFM | 5 | — | 12 (F17) |
| Comp. Ex. 2 | 100 | — | — | 30 (P) | — | — | OFM | 5 | — | 33 (F17) |
| Comp. Ex. 3 | 100 | — | — | — | — | 5 (PERSOFTEL) | OFM | 5 | — | — |

*1 As the polyvinyl alcohol, “P” represents JP-05 having a degree of saponification of 88 mol %, “A” represents PVA-706 having a degree of saponification of 91.5 mol %, “F17” represents JF-17 having a degree of saponification of 98.5 mol %, and “F05” represents JF-05 having a degree of saponification of 98.5 mol %.

TABLE 2

| | | | | | | remaining amount of volatile active substance | | | | |
|---|---|---|---|---|---|---|---|---|---|---|
| | | | | | | weight ratio relative to the initial amount | | | | |
| | | | | | | | | | | the day when |
| | | glass transition | | | | | | | | remaining amount |
| | molar ratio of | temperature of | | evaporation | | 10 | 20 | 30 | 40 | reached |
| | hydrophilic part | polymer *2 | viscosity | residue | weather | days | days | days | days | not more than 5% |
| | to acetate part | (° C.) | (mPa · s) | (%) | resistance | later *3 | later *3 | later *3 | later *3 | (day) |
| Example 1 | 14.4 | 30 | 50 | 40.3 | High | 62 | 47 | 41 | 28 | 91 |
| Example 2 | 13.0 | 30 | 70 | 40.4 | Medium | 68 | 53 | 35 | 25 | 86 |
| Example 3 | 15.5 | 30 | 40 | 40.0 | High | 73 | 58 | 39 | 28 | 94 |
| Example 4 | 14.4 | 30 | 50 | 40.3 | High | 67 | 52 | 32 | 23 | 95 |
| Example 5 | 14.4 | 30 | 50 | 40.3 | High | 68 | 54 | 39 | 31 | 100 |
| Example 6 | 14.4 | 30 | 50 | 40.3 | High | 66 | 49 | 32 | 24 | 81 |
| Example 7 | 14.4 | 30 | 60 | 40.3 | High | 67 | 50 | 30 | 21 | 77 |
| Example 8 | 13.3 | −17 | 40 | 40.3 | High | 69 | 56 | 39 | 30 | 86 |
| Example 9 | 14.4 | −47 | 50 | 40.3 | High | 67 | 53 | 37 | 28 | 93 |
| Example10 | 14.4 | 30 | 60 | 40.3 | High | 65 | 53 | 37 | 29 | 94 |
| Example11 | 14.1 | 30 | 60 | 40.3 | High | 70 | 57 | 39 | 30 | 100 |
| Example12 | 12.2 | 30 | 70 | 35.1 | High | 70 | 58 | 42 | 32 | 104 |
| Comp. Ex. 1 | 13.7 | 30 | 55 | 36.1 | Low | 98 | 98 | 97 | 97 | not measurable |
| Comp. Ex. 2 | 15.0 | 30 | 70 | 38.5 | Low | 93 | 93 | 92 | 92 | not measurable |
| Comp. Ex. 3 | — | 30 | 78 | 51.0 | High | 76 | 73 | 72 | 72 | not measurable |

*2 value obtained by calculation based on equation (1).
*3 weight ratio relative to the initial amount which is regarded as 100.

The sustained release preparations in Comparative Example 1 and 2 had the degraded weather resistances and had significantly low release rates, In Comparative Example 1, the polyvinyl alcohol (C1) having a degree of saponification of more than 82 mol % but not more than 91.5 mol % was contained in an amount of 40% by weight relative to the total amount of the ethylenically unsaturated group-containing monomers (A) and the total amount of the polyvinyl alcohols (C1) and (C3) was 52% by weight relative to the total amount of the ethylenically unsaturated group-containing monomers (A). In Comparative Example 2, the polyvinyl alcohol (C3) having a degree of saponification of not less than 98 mol % was contained in an amount of 33% by weight relative to the total amount of the ethylenically unsaturated group-containing monomers (A) and the total amount of polyvinyl alcohols (C1) and (C3) was 63% by weight relative to the ethylenically unsaturated group-containing monomers (A).

The sustained release preparation in Example 2 in which the total amount of the polyvinyl alcohols (C1) and (C3) was 34% by weight relative to the total amount of the ethylenically unsaturated group-containing monomers (A), could have a constant release rate. However, the weather resistant thereof was slightly degraded, contrary to those in Examples 3 and 12 and those in Examples 1 and 4 to 11. In Examples 3 and 12, the total amount of the polyvinyl alcohols (C1) and (C3) was 15% by weight relative to the ethylenically unsaturated group-containing monomers (A), In Examples 1 and 4 to 11, the total amount of the polyvinyl alcohols (C1) and (C3) was 12% by weight.

### Examples 13 to 37 and Comparative Examples 4 to 13

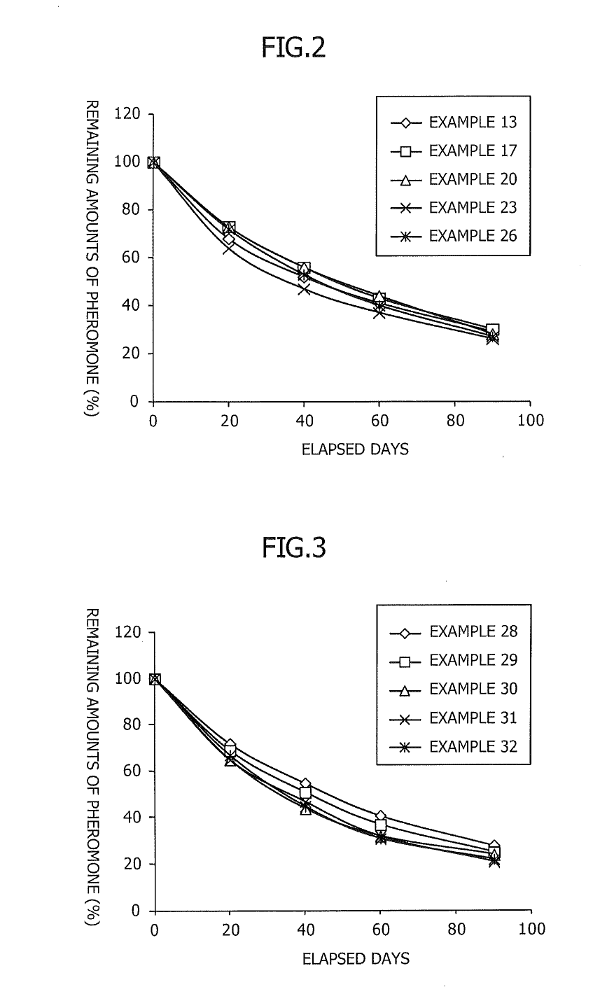

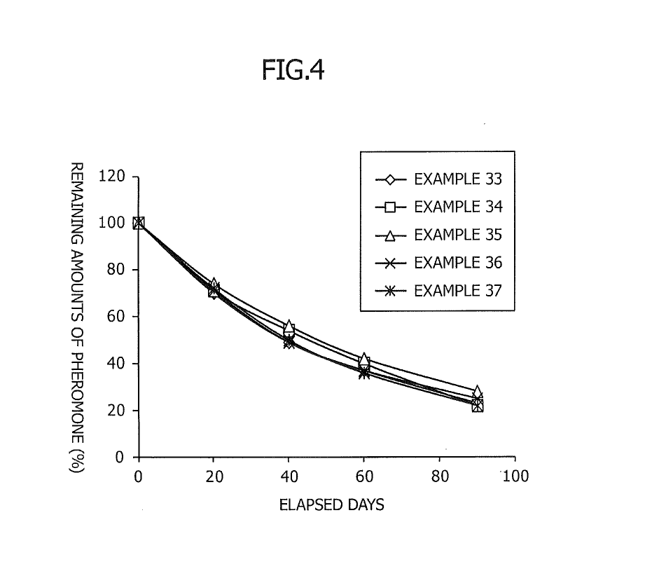

The polymer particle water dispersion and the sustained release preparation were produced based on the polymerization compositions with and without an addition after the polymerization as shown in Tables 3 and 5 in the same manner as in Example 1. The same tests as those in Example 1 were conducted. As the volatile active substance other than the pheromone substance, an aromatic of leaf alcohol (boiling point of 156° C.), limonene (boiling point of 176° C.) or citral (boiling point of 229° C.), an agricultural chemical of diazinon (decomposed at 120° C.), and a deodorant of lauryl methacrylate (boiling point of 305° C.) were used. The results are shown in Tables 4 and 6 and FIGS. 2 and 3.

TABLE 3

| | polymerization step | | | | | | after polymerization | | |
|---|---|---|---|---|---|---|---|---|---|
| | (part by weight) | | | | | | (part by weight) | | |
| | Monomer | | | | | polyvinyl | | | polyvinyl |
| | vinyl | butyl | ethyl | acrylic | | alcohol | | | alcohol |
| | acetate | acetate | acetate | acid | ethylene | (C1) *1 | volatile active substance | | (C3) *1 |
| Example 13 | 70 | 28 | — | 2 | — | 8 (P) | leaf alcohol | 6 | 8 (F05) |
| Example 14 | 70 | — | 30 | — | — | 10 (P) | leaf alcohol | 14 | 5 (F05) |
| Example 15 | — | — | 100 | — | — | 10 (P) | leaf alcohol | 10 | 10 (F05) |
| Example 16 | 80 | — | — | — | 20 | 15 (P) | leaf alcohol | 6 | 10 (F05) |
| Example 17 | 80 | 18 | — | 2 | — | 11 (P) | limonene | 6 | 12 (F05) |
| Example 18 | 55 | 43 | — | 2 | — | 12 (P) | limonene | 12 | 10 (F05) |
| Example 19 | 75 | — | — | — | 25 | 17 (P) | limonene | 6 | 8 (F05) |
| Example 20 | 70 | — | 30 | — | — | 10 (P) | citral | 6 | 10 (F05) |
| Example 21 | 100 | — | — | — | — | 6 (P) | citral | 15 | 5 (F05) |
| Example 22 | 70 | — | — | — | 30 | 18 (P) | citral | 6 | 7 (F05) |
| Example 23 | 70 | 28 | — | 2 | — | 15 (P) | diazinon | 6 | 5 (F05) |
| Example 24 | — | 98 | — | 2 | — | 19 (P) | diazinon | 6 | 7 (F05) |
| Example 25 | 80 | — | — | — | 20 | 15 (P) | diazinon | 6 | 10 (F05) |
| Example 26 | 70 | 28 | — | 2 | — | 10 (P) | lauryl methacrylate | 6 | 2 (F05) |
| Example 27 | 70 | — | — | — | 30 | 18 (P) | lauryl methacrylate | 6 | 7 (F05) |
| Comp. Ex. 4 | 70 | 28 | — | 2 | — | 40 (A) | leaf alcohol | 6 | 12 (F05) |
| Comp. Ex. 5 | 70 | — | 30 | — | — | 30 (P) | leaf alcohol | 14 | 33 (F17) |
| Comp. Ex. 6 | 80 | 18 | — | 2 | — | 35 (A) | limonene | 6 | 10 (F05) |
| Comp. Ex. 7 | 55 | 43 | — | 2 | — | 30 (P) | limonene | 12 | 32 (F17) |
| Comp. Ex. 8 | 70 | — | 30 | — | — | 35 (P) | citral | 6 | 15 (F17) |
| Comp. EX. 9 | 100 | — | — | — | — | 30 (P) | citral | 15 | 33 (F05) |
| Comp. Ex. 10 | 70 | 28 | — | 2 | — | 39 (A) | diazinon | 6 | 17 (F05) |
| Comp. Ex. 11 | — | 98 | — | 2 | — | 30 (P) | diazinon | 6 | 32 (F05) |
| Comp. Ex. 12 | 70 | 28 | — | 2 | — | 35 (P) | lauryl methacrylate | 6 | 12 (F05) |
| Comp. Ex. 13 | 70 | — | — | — | 30 | 30 (P) | lauryl methacrylate | 6 | 33 (F17) |

*1 As the polyvinyl alcohol, “P” represents JP-05 having a degree of saponification of 88 mol %, “A” represents PVA-706 having a degree of saponification of 91.5 mol %, “F17” represents JF-17 having a degree of saponification of 98.5 mol %, and “F05” represents JF-05 having a degree of saponification of 98.5 mol %.

TABLE 4

| | molar | glass | | | | remaining amount of volatile active substance | | | | |
|---|---|---|---|---|---|---|---|---|---|---|
| | ratio of | transition | | | | weight ratio relative to the initial amount | | | | |
| | hydrophilic | temperature | | | | | | | | the day when |
| | part to | of | | evaporation | | 20 | 40 | 60 | 90 | remaining amount reached |
| | acetate | polymer *2 | viscosity | residue | weather | days | days | days | days | not more than 5% |
| | part | (° C.) | (mPa · s) | (%) | resistance | later *3 | later *3 | later *3 | later *3 | (day) |
| Example 13 | 14.4 | 0 | 65 | 40.1 | — | 68 | 52 | 41 | 29 | 200 |
| Example 14 | 11.1 | 11 | 80 | 40.2 | — | 64 | 46 | 34 | 22 | 167 |
| Example 15 | 14.4 | −22 | 70 | 40.2 | — | 64 | 45 | 35 | 29 | 188 |
| Example 16 | 12.2 | 7 | 90 | 55.0 | — | 70 | 53 | 42 | 30 | 214 |
| Example 17 | 14.9 | 9 | 70 | 41.4 | — | 73 | 56 | 43 | 30 | 212 |
| Example 18 | 13.3 | 4 | 75 | 39.9 | — | 65 | 47 | 38 | 27 | 187 |
| Example 19 | 10.9 | −7 | 90 | 55.0 | — | 71 | 54 | 41 | 28 | 199 |
| Example 20 | 14.4 | 11 | 60 | 40.2 | — | 73 | 56 | 44 | 28 | 212 |
| Example 21 | 13.3 | 30 | 65 | 42.7 | — | 70 | 52 | 39 | 27 | 200 |
| Example 22 | 10.3 | −19 | 90 | 55.0 | — | 70 | 53 | 41 | 25 | 200 |
| Example 23 | 9.9 | 0 | 80 | 40.3 | High | 64 | 47 | 37 | 26 | 189 |
| Example 24 | 10.1 | −50 | 90 | 40.3 | High | 62 | 43 | 34 | 24 | 177 |
| Example 25 | 12.2 | 7 | 90 | 55.0 | High | 67 | 50 | 40 | 29 | 201 |
| Example 26 | 8.9 | 0 | 65 | 40.7 | — | 72 | 53 | 40 | 27 | 200 |
| Example 27 | 10.3 | −19 | 90 | 55.0 | — | 69 | 52 | 39 | 26 | 201 |
| Comp. Ex. 4 | 13.7 | 0 | 85 | 36.5 | — | 98 | 97 | 97 | 97 | not measurable |
| Comp. Ex. 5 | 15.0 | 11 | 90 | 38.3 | — | 94 | 94 | 92 | 91 | not measurable |
| Comp. Ex. 6 | 13.6 | 9 | 85 | 38.6 | — | 96 | 94 | 94 | 94 | not measurable |
| Comp. Ex. 7 | 14.8 | 4 | 90 | 36.3 | — | 93 | 92 | 92 | 91 | not measurable |
| Comp. Ex. 8 | 10.6 | 11 | 80 | 38.0 | — | 97 | 97 | 95 | 95 | not measurable |
| Comp. Ex. 9 | 15.0 | 30 | 90 | 39.4 | — | 96 | 96 | 96 | 94 | not measurable |
| Comp. Ex. 10 | 14.9 | 0 | 95 | 37.5 | Low | 98 | 98 | 97 | 96 | not measurable |
| Comp. Ex. 11 | 14.8 | −50 | 100 | 37.6 | Low | 94 | 93 | 92 | 92 | not measurable |
| Comp. Ex. 12 | 10.0 | 0 | 85 | 37.9 | — | 97 | 94 | 94 | 94 | not measurable |
| Comp. Ex. 13 | 15.0 | −19 | 100 | 52.1 | — | 96 | 95 | 94 | 92 | not measurable |

*2 value obtained by calculation based on equation (1).
*3 weight ratio relative to the initial amount which is regarded as 100.

TABLE 5

| | polymerization step | | | | | | after polymerization | | |
|---|---|---|---|---|---|---|---|---|---|
| | (part by weight) | | | | | | (part by weight) | | |
| | Monomer | | | | polyvinyl | polyvinyl | | | polyvinyl |
| | vinyl | butyl | ethyl | acrylic | Alcohol | alcohol | volatile active | | alcohol |
| | acetate | acetate | acetate | acid | (C1) *1 | (C3) *1 | substance | | (C1) *1 |
| Example 28 | 70 | 28 | — | 2 | — | 8 (F05) | leaf alcohol | 6 | 8 (P) |
| Example 29 | 80 | 18 | — | 2 | — | 11 (F05) | limonene | 6 | 12 (P) |
| Example 30 | 70 | — | 30 | — | — | 10 (F05) | citral | 6 | 10 (P) |
| Example 31 | 70 | 28 | — | 2 | — | 11 (F05) | diazinon | 6 | 10 (P) |
| Example 32 | 70 | 28 | — | 2 | — | 10 (F05) | lauryl methacrylate | 6 | 10 (P) |
| Example 33 | 70 | 28 | — | 2 | 8 (P) | 5 (F05) | leaf alcohol | 6 | — |
| Example 34 | 80 | 18 | — | 2 | 11 (P) | 5 (F05) | limonene | 6 | — |
| Example 35 | 70 | — | 30 | — | 10 (P) | 5 (F05) | citral | 6 | — |
| Example 36 | 70 | 28 | — | 2 | 15 (P) | 2 (F05) | diazinon | 6 | — |
| Example 37 | 70 | 28 | — | 2 | 10 (P) | 2 (F05) | lauryl methacrylate | 6 | — |

*1 As the polyvinyl alcohol, “P” represents JP-05 having a degree of saponification of 88 mol %, and “F05” represents JF-05 having a degree of saponification of 98.5 mol %.

TABLE 6

| | | | | | | remaining amount of volatile active substance | | | | |
|---|---|---|---|---|---|---|---|---|---|---|
| | | | | | | weight ratio relative to the initial amount | | | | |
| | | | | | | | | | | the day when |
| | | glass transition | | | | | | | | remaining amount |
| | molar ratio of | temperature of | | evaporation | | 20 | 40 | 60 | 90 | reached |
| | hydrophilic part | polymer *2 | viscosity | residue | weather | days | days | days | days | not more than 5% |
| | to acetate part | (° C.) | (mPa · s) | (%) | resistance | later *3 | later *3 | later *3 | later *3 | (day) |
| Example 28 | 14.4 | 0 | 70 | 39.9 | — | 72 | 55 | 41 | 28 | 199 |
| Example 29 | 13.9 | 9 | 70 | 40.5 | — | 69 | 51 | 37 | 25 | 204 |
| Example 30 | 14.4 | 11 | 75 | 40.4 | — | 65 | 44 | 32 | 24 | 175 |
| Example 31 | 15.0 | 0 | 75 | 40.1 | High | 65 | 47 | 32 | 21 | 164 |
| Example 32 | 14.4 | 0 | 70 | 40.7 | — | 67 | 45 | 31 | 22 | 170 |
| Example 33 | 11.9 | 0 | 60 | 40.3 | — | 70 | 49 | 37 | 23 | 166 |
| Example 34 | 10.8 | 9 | 65 | 40.2 | — | 71 | 54 | 40 | 22 | 168 |
| Example 35 | 11.1 | 11 | 65 | 40.5 | — | 74 | 56 | 42 | 28 | 197 |
| Example 36 | 8.4 | 0 | 70 | 40.3 | High | 71 | 49 | 37 | 25 | 202 |
| Example 37 | 8.9 | 0 | 65 | 40.1 | — | 72 | 50 | 36 | 22 | 171 |

*2 value obtained by calculation based on equation (1).
*3 weight ratio relative to the initial amount which is regarded as 100.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A sustained release preparation comprising:
a water dispersion having viscosity at 25° C. of not more than 100 mPa·s and comprising
polymer particles which are obtained by polymerizing ethylenically unsaturated group-containing monomers (A),
polyvinyl alcohol (C1) in an amount of more than 0% by weight but not more than 30% by weight relative to a total amount of the ethylenically unsaturated group-containing monomers (A), having a degree of saponification of more than 82 mol % but not more than 91.5 mol %,
polyvinyl alcohol (C3) in an amount of more than 0% by weight but not more than 30% by weight relative to the total amount of the ethylenically unsaturated group-containing monomers (A), having a degree of saponification of not less than 98 mol %, and
water,
wherein a total amount of the polyvinyl alcohols (C1) and (C3) is more than 0% by weight but not more than 50% by weight relative to the total amount of ethylenically unsaturated group-containing monomers (A), and
a volatile active substance which is selected from a group consisting of a pheromone substance, an agricultural chemical, an aromatic, a deodorant and an antibacterial agent.

2. The sustained release preparation according to claim 1, wherein a ratio of an molar amount of hydrophilic part to an molar amount of acetate part is not more than 15.0, the former being a total molar amount of vinyl alcohol monomer units and the latter being a total molar amount of vinyl acetate monomer units in the total amount of the polyvinyl alcohols (C1) and (C3).

3. The sustained release preparation according to claim 1, wherein the volatile active substance is in an amount of from 3 to 20% by weight relative to the total amount of the ethylenically unsaturated group-containing monomers (A) comprised by the water dispersion.

4. The sustained release preparation according to claim 1, wherein the volatile active substance is a compound selected from a group consisting of acetate, alcohol (including phenol), epoxide, alkane, alkene, aldehyde, ketone, carboxylic acid, ester and ether, each having a boiling point of from 100° C. to 350° C. and having six to twenty carbon atoms.

5. A method for producing a sustained release preparation comprising:
a polymerization step of emulsion-polymerizing ethylenically unsaturated group-containing monomers (A) in the presence of polyvinyl alcohol to obtain a polymer particle water dispersion having viscosity at 25° C. of not more than 100 mPa·s, wherein
the polyvinyl alcohol is selected from polyvinyl alcohol (C1) having a degree of saponification of more than 82 mol % but not more than 91.5 mol % and polyvinyl alcohol (C3) having a degree of saponification of not less than 98 mol %; and
when the polyvinyl alcohol is a combination of the polyvinyl alcohols (C1) and (C3), both of the polyvinyl alcohols (C1) and (C3) are present during the polymerization, or one of the polyvinyl alcohols (C1) and (C3) is present during the polymerization and the other of the polyvinyl alcohols, which is not present during the polymerization, is blended after the polymerization, so that the polyvinyl alcohol (C1) is in an amount of more than 0% by weight but not more than 30% by weight, the polyvinyl alcohol (C3) is in an amount of more than 0% by weight but not more than 30% by weight, and a total amount of the polyvinyl alcohols (C1) and (C3) is more than 0% by weight but not more than 50% by weight relative to a total amount of the ethylenically unsaturated group-containing monomers (A); and
a mixing step of mixing the polymer particle water dispersion with a volatile active substance selected from a group consisting of a pheromone substance, an agricultural chemical, an aromatic, a deodorant and an antibacterial agent.

6. The method for producing a sustained release preparation according to claim 5, wherein the polyvinyl alcohol is a combination of the polyvinyl alcohols (C1) and (C3), and both of the polyvinyl alcohols (C1) and (C3) are present during the polymerization.

7. The method for producing a sustained release preparation according to claim 5, wherein the polyvinyl alcohol is a combination of the polyvinyl alcohols (C1) and (C3), and the polyvinyl alcohol (C1) is present during the polymerization and the polyvinyl alcohol (C3) is blended after the polymerization.

8. The method for producing a sustained release preparation according to claim 5, wherein the polyvinyl alcohol is a combination of the polyvinyl alcohols (C1) and (C3), and the polyvinyl alcohol (C3) is present during the polymerization and the polyvinyl alcohol (C1) is blended after the polymerization.
